(19) United States
(12) Patent Application Publication
(10) Pub. No.: US 2026/0036492 A1
(43) Pub. Date: Feb. 5, 2026

(54) REMOTE DIAGNOSTIC SYSTEM AND METHOD FOR DEGRADATION OF STRUCTURAL COMPONENTS

(71) Applicant: INDUSTRIAL TECHNOLOGY RESEARCH INSTITUTE, Hsinchu (TW)

(72) Inventors: Yao-Long TSAI, Hsinchu County (TW); Shih-Neng LIN, Tainan City (TW); Wei-Yi CHUANG, Hsinchu City (TW); Yuan Heng SUN, New Taipei City (TW)

(73) Assignee: INDUSTRIAL TECHNOLOGY RESEARCH INSTITUTE, Hsinchu (TW)

(21) Appl. No.: 19/005,686

(22) Filed: Dec. 30, 2024

(30) Foreign Application Priority Data
Jul. 31, 2024 (TW) 113128519

(51) Int. Cl. G01M 99/00; G01B 11/16; G01B 11/24; G01B 17/04; G01B 17/06; G06T 7/00; G06T 7/60; H04R 1/40

(52) U.S. Cl. CPC G01M 99/005; G01B 11/16; G01B 11/24; G01B 17/04; G01B 17/06; G06T 7/0004; G06T 7/60; H04R 1/406; G06T 2207/10016; G06T 2207/20084; H04R 2430/20

(57) ABSTRACT

A remote diagnostic system for degradation of structural component includes a shape detection module and a computing device. The shape detection module obtains at least one shape data of the structural component remotely in a non-contact manner. The shape detection module includes at least one of an acoustic sensor and an optical sensor. The computing device is communicably connected to the shape detection module. The computing device calculates at least one modal shape of the structural component based on the at least one shape data and determines a defect location of the structural component based on the at least one modal shape.

### CROSS-REFERENCE TO RELATED APPLICATIONS

This non-provisional application claims priority under 35 U.S.C. § 119(a) on Patent Application No(s). 113128519 filed in Taiwan on Jul. 31, 2024, the entire contents of which are hereby incorporated by reference.

### BACKGROUND

### 1. Technical Field

The present disclosure relates to the detection of object vibration displacement, specifically a remote diagnostic system and method for the degradation of structural components.

### 2. Related Art

In response to the trend of global warming and the promotion of clean energy development, offshore wind power has become a practical solution. As wind turbines are installed at sea, their core components, including turbine blades, transmission systems, and foundational structures, are susceptible to natural factors such as weather, ocean currents, earthquakes, and lightning strikes, which can lead to structural damage and affect power generation stability. Therefore, regular maintenance or repairs are necessary.

Currently, the inspection of offshore wind turbines primarily relies on offline manual inspections, which have relatively high maintenance costs. Other inspection technologies are constrained by factors such as weather, regulations, and the experience of manual diagnostics. Offline operations for turbine component inspection include visual inspections, ultrasonic testing, and acoustic leakage detection. In online operations, in addition to vibration monitoring, human hearing is mainly relied upon to assess the structural damage of turbines. Another inspection method involves using accelerometers installed on turbine components for point monitoring.

### SUMMARY

According to one or more embodiment of the present disclosure, a remote detection system for degradation of structural component includes a shape detection module and a computing device. The shape detection module obtains at least one shape data of a structural component remotely in a non-contact manner. The shape detection module includes at least one of an acoustic sensor and an optical sensor. The computing device is communicably connected to the shape detection module. The computing device is configured to calculate at least one modal shape of the structural component according to the at least one shape data and determine a defect location of the structural component according to the at least one modal shape.

According to one or more embodiment of the present disclosure, a remote diagnostic method for degradation of structural component includes: obtaining at least one shape data of a structural component remotely in a non-contact manner by a shape detection module, wherein the shape detection module comprises at least one of an acoustic sensor and an optical sensor; calculating at least one modal shape of the structural component according to the at least one shape data by a computing device; and determining a defect location of the structural component according to the at least one modal shape.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the remote diagnostic system for degradation of structural component according to the first embodiment of the present disclosure;

FIG. 2 is an example of an image file captured by an acoustic camera of a wind turbine;

FIG. 3A and FIG. 3B are comparison diagrams of vibration signals from vibration tests on a simply supported structure;

FIG. 4A and FIG. 4B are comparison diagrams of vibration signals from vibration tests on a cantilever structure;

FIG. 5 is a comparison diagram of vibration signals from vibration tests on a structural component;

FIG. 6A and FIG. 6B are comparison diagrams of modal shapes constructed by an acoustic sensor and an optical sensor for a simply supported structure;

FIG. 7 is a block diagram of the remote diagnostic system for degradation of structural component according to the second embodiment of the present disclosure;

FIG. 8 is a defect modal shape table of a simply supported structure;

FIG. 9 is a defect modal shape table of a cantilever structure;

FIG. 10 is an example schematic diagram of the deformation amount of a structural component;

FIG. 11 is a flowchart of the remote diagnostic method for degradation of structural component according to the first embodiment of the present disclosure;

FIG. 12 is a flowchart of the remote diagnostic method for degradation of structural component according to the second embodiment of the present disclosure; and

FIG. 13 is a detailed flowchart of one step in FIG. 12.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

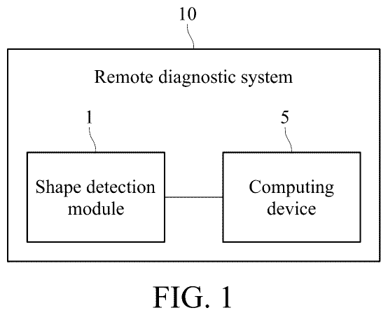

The remote diagnostic system of the present disclosure diagnoses degradations of structural components through remotely capturing in a non-contact manner, thereby eliminating the need to pre-install sensing devices on the structural component. FIG. 1 is a block diagram of the remote diagnostic system for degradation of structural component according to the first embodiment of the present disclosure. As shown in FIG. 1, the remote diagnostic system 10 for degradation of structural component includes a shape detection module 1 and a computing device 5, these two components communicate with each other, for example, through wireless communication. In an embodiment, the shape detection module 1 may transmit data to the cloud, from which the computing device 5 retrieves the data, performs diagnostics, and then instantly sends the diagnostic results to the user's mobile phone or computer.

The shape detection module 1 includes at least one of an acoustic sensor and an optical sensor. The shape detection module 1 is configured to capture time-frequency data, instantly tracking the frequency changes and displacement responses of the structural component in different directions. In an embodiment, the shape detection module 1 may include, for example, a camera, microphone, laser transceiver, or infrared transceiver, and these devices may remotely obtain at least one shape data of the structural component in a non-contact manner. In this context, “remote” specifically refers to a distance between the shape detection module 1 and the structural component exceeding a threshold. In an embodiment, this threshold is 100 meters, but the present disclosure is not limited thereto.

In an embodiment, the computing device 5 may be implemented using at least one of the following examples: a microcontroller (MCU), an application processor (AP), a field-programmable gate array (FPGA), an application-specific integrated circuit (ASIC), a system-on-a-chip (SOC), a deep learning accelerator, or any electronic device with similar functions. However, the present disclosure is not limited to the above examples.

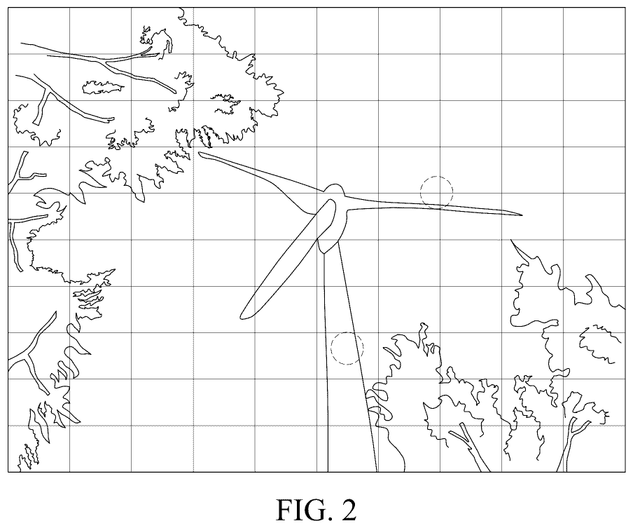

In an embodiment of the shape detection module 1, the acoustic sensor is an acoustic camera. The acoustic camera, equipped with a microphone array, captures the structural component to generate both an image file and an audio file of, which serve as the aforementioned shape data. FIG. 2 is an example of an image file captured by an acoustic camera of a wind turbine.

The image file includes a plurality of frames. Each frame may be divided into a plurality of locations, as shown in the grids of FIG. 2. Each location's sound has a directional angle relative to a reference point (e.g., the center of the image). The operator may designate a specific location in a frame, such as a grid containing the structural component (e.g., a wind turbine blade). In the following embodiments, the wind turbine blade is used as an example of a structural component, but the present disclosure is not limited to this. Since the position of the wind turbine blade changes at every moment during rotation, the computing device 5 needs to analyze the audio source in the image to dynamically adjust the directional angle of the designated location to achieve dynamic tracking of the audio source from the moving structural component. In an embodiment, the computing device 5 performs adaptive beamforming according to the designated location and the audio file to amplify a sound amplitude at the designated location while attenuating the sound amplitude outside the designated location.

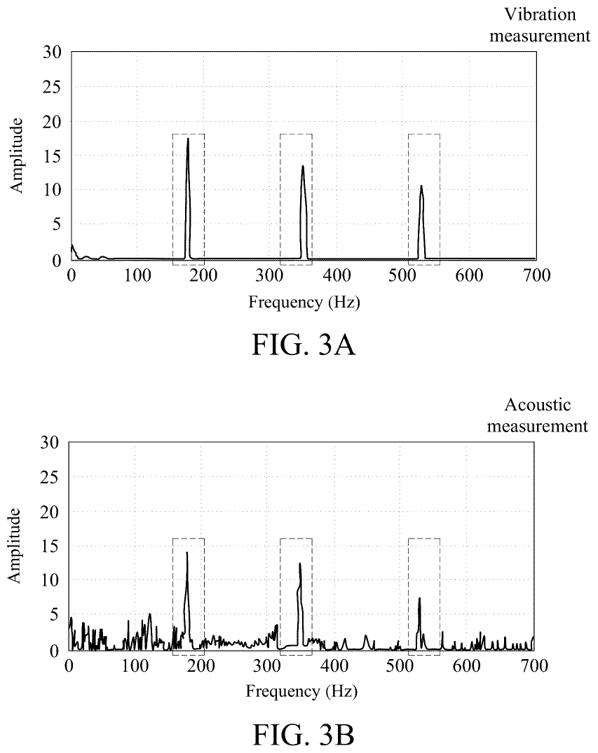

FIG. 3A and FIG. 3B are comparison diagrams of vibration signals from vibration tests on a simply supported structure. FIG. 3A shows the vibration spectrum measured by an accelerometer installed on the structural component of the simply supported structure, while FIG. 3B shows the vibration spectrum obtained through the acoustic sensor and the beamforming algorithm. As illustrated, the characteristic frequency profiles of FIG. 3A and FIG. 3B are consistent, indicating that the directional audio signal matches the vibration signal from the accelerometer at the same location.

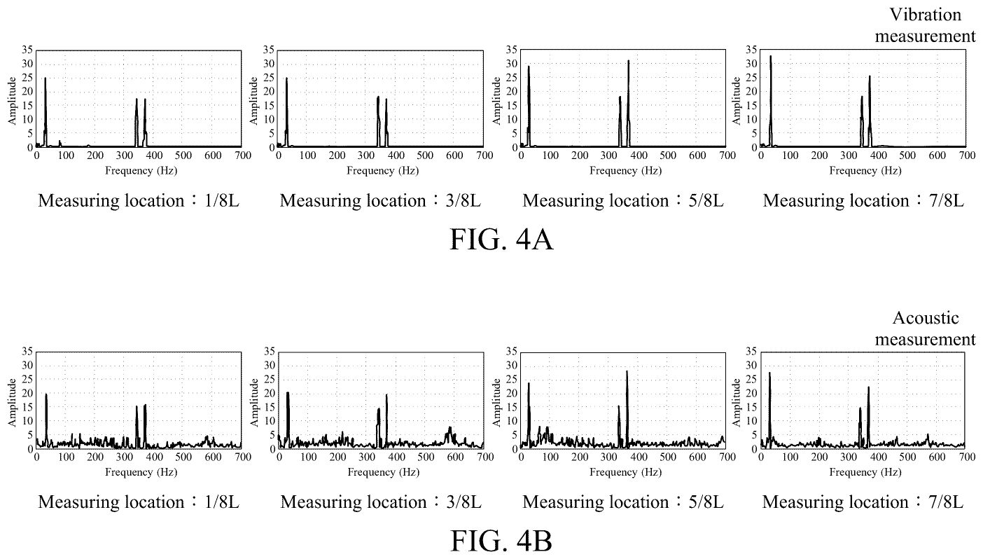

FIG. 4A and FIG. 4B are comparison diagrams of vibration signals from vibration tests on a cantilever structure. FIG. 4A shows the vibration spectrum measured by accelerometers at a plurality of designated locations on the cantilever structure, while FIG. 4B shows the vibration spectrum obtained at those designated locations through the acoustic sensor and the beamforming algorithm. The designated locations include ⅛L, 4/8L, ⅝L, and ⅞L, where L represents the length of the structural component (e.g., a wind turbine blade). As illustrated, the characteristic frequency profiles of FIG. 4A and FIG. 4B are consistent, indicating that the directional audio signal matches the vibration signal from the accelerometer at the same location. The experiments shown in FIGS. 3A, 3B, 4A, and 4B verify the effectiveness of the acoustic sensor adopted in an embodiment of the present disclosure.

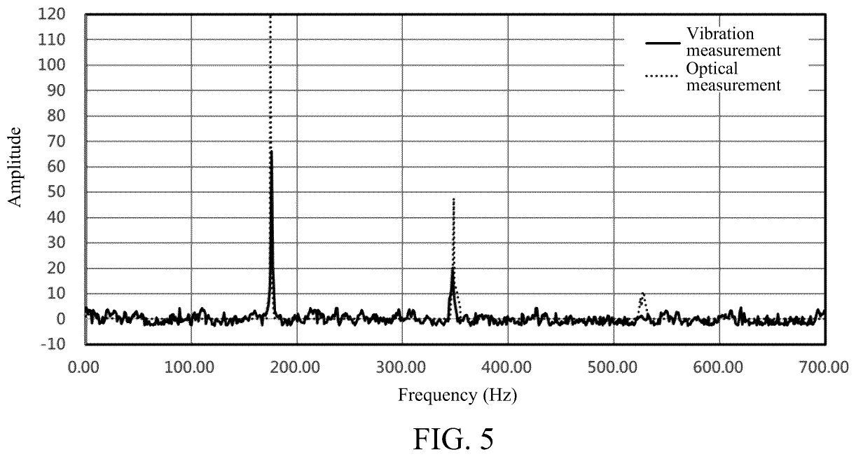

In another embodiment of the shape detection module 1, the optical sensor is a high-speed camera. The high-speed camera captures the structural component to generate a video as the shape data. The operator selects the contour of the structural component to be tracked in the video, and the computing device 5 then executes an artificial intelligence algorithm on the video to calculate the motion trajectory of the structural component. The vibration frequency is then calculated based on the displacement along the motion trajectory in the image plane. Specifically, the artificial intelligence algorithm is, for example, YOLO (You Only Look Once). The computing device 5 uses the YOLO smart video recognition algorithm to analyze the displacement of points on the surface of the structural component by capturing its surface contour, thereby determining the displacement response and modal shapes of the structural component. The minimum detectable displacement depends on the frame rate (frame per second, fps), image resolution, and optical lens magnification, but the present disclosure is not limited to these factors. FIG. 5 is a comparison diagram of vibration signals from a vibration test on the structural component, where the solid line represents vibration measurements obtained using an accelerometer, and the dashed line represents optical measurements obtained using an optical sensor. As shown in FIG. 5, the characteristic frequencies of the two vibration modes exhibit similar distributions, indicating that the dynamic trajectory response in the video matches the vibration signal from the accelerometer at the same location.

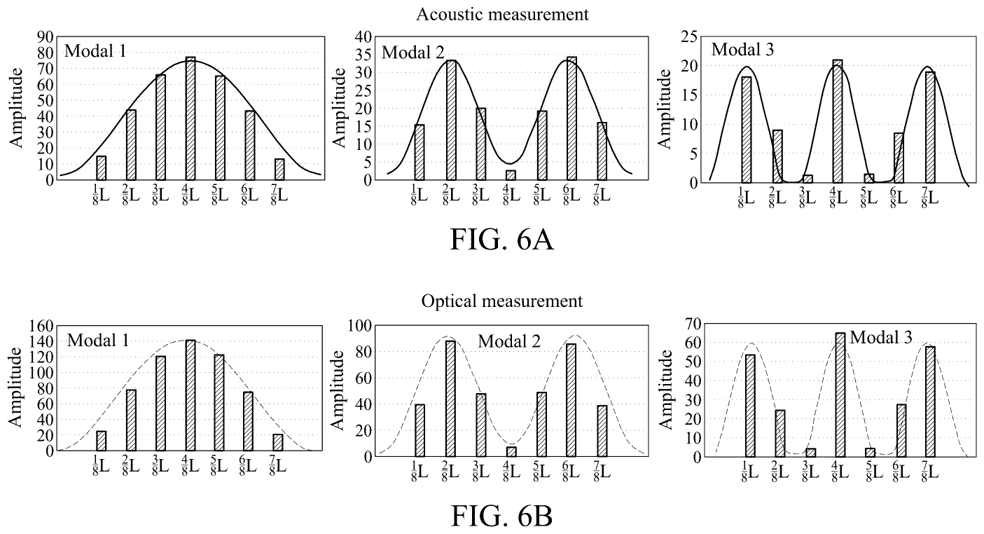

FIG. 6A and FIG. 6B are comparison diagrams of modal shapes constructed by an acoustic sensor and an optical sensor, respectively, for a simply supported structure. As illustrated, in modal 1 through modal 3, both the modal shapes constructed by the acoustic sensor in FIG. 6A and those constructed by the optical sensor in FIG. 6B exhibit the same amplitude characteristics. In other words, by using an acoustic camera (acoustic) or a high-speed camera (optical) to remotely capture and track the audio and image signals at the location of the structural component, the vibration responses at all designated locations of the structural component can be fully analyzed, and the modal shape waveform can be constructed.

It should be noted that the shape detection module 1 described in the present disclosure may utilize at least one of either an acoustic sensor or an optical sensor. In other words, an acoustic sensor may be used alone, an optical sensor may be used alone, or both acoustic and optical sensors may be used together.

The remote diagnostic system 10 for degradation of structural component in the first embodiment is applicable to the structural component that includes at least three components with the same structure, such as fan blades. After the shape detection module 1 obtains at least three shape data points corresponding to the at least three components, the computing device 5 calculates the modal shape for each shape data point in the aforementioned manner, thereby generating at least three modal shapes. The computing device 5 determines the defect location of the structural component in the following way: it identifies a candidate modal among the at least three modal shapes, where the modals other than the candidate modal are the same, and the candidate modal differs from the others. Therefore, the defect location corresponds to one of the at least three components associated with the candidate modal. For example, if the modal shape corresponding to blade A differs from that of blades B and C, and blades B and C share similar modal shapes, this indicates that blade A is more likely to have a defect.

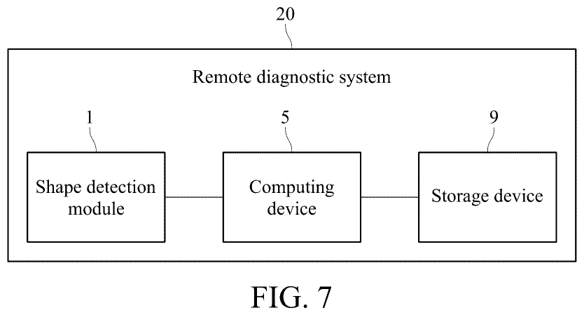

FIG. 7 is a block diagram of the remote diagnostic system for degradation of structural component according to the second embodiment of the present disclosure. Compared to the first embodiment, the remote diagnostic system 10 in the second embodiment further includes a storage device 9, which is communicably connected to the computing device 5.

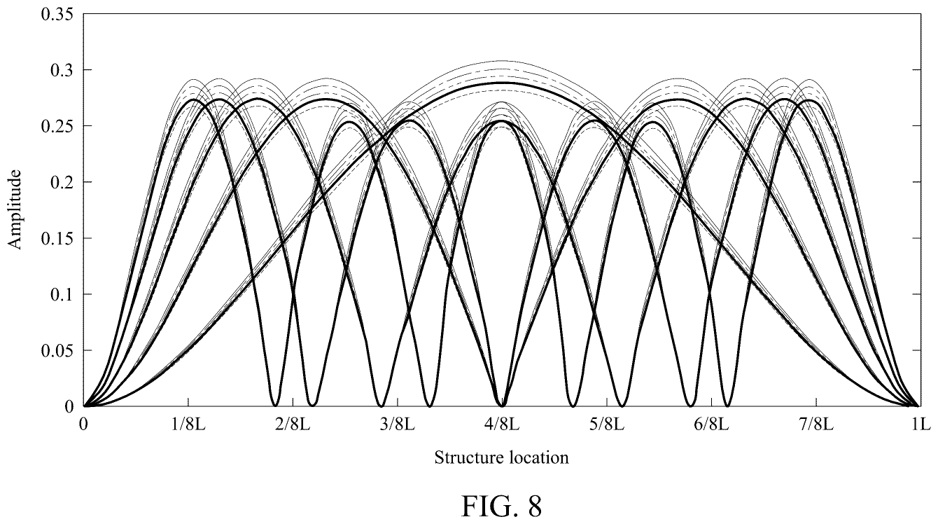

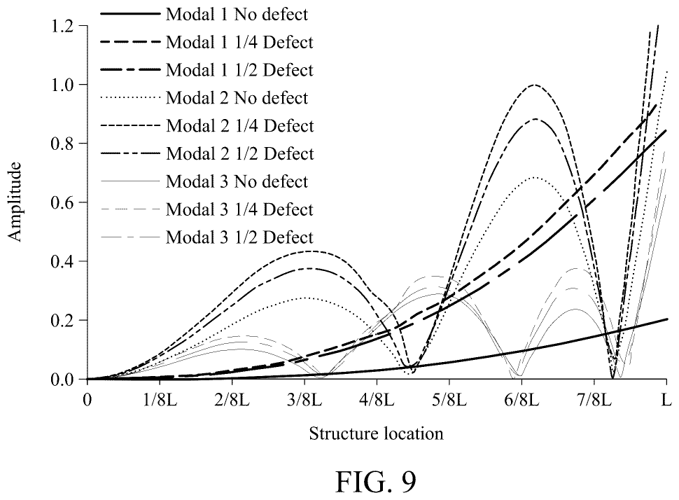

In an embodiment, the storage device 9 is used to store a defect modal shape table, which records a plurality of reference modal shapes corresponding to a plurality of frequencies. FIG. 8 shows a defect modal shape table for a simply supported structure, and FIG. 9 shows a defect modal shape table for a cantilever structure. In an embodiment, the defect modal shape table is established by the Finite Element Method (FEM). The computing device 5 performs FEM simulation analysis on the modal shapes of the structural component to establish a modal shape database of degradation of structural component, as shown in FIG. 8 and FIG. 9. The computing device 5 then performs a plurality of selections according to these reference modals to determine the defect location of the structural component.

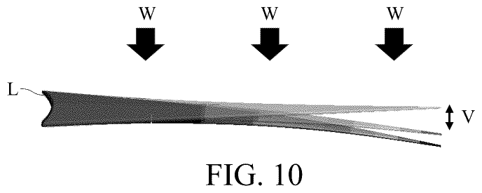

In another embodiment, the storage device 9 is configured to store a relationship between a defect size and a deformation amount. FIG. 10 is an example schematic diagram of the deformation amount of a structural component. The structural component L shown in FIG. 10 is a wind turbine blade with a length of 70 meters, a root width of 6 meters, and a tip width of 3 meters. When the wind direction W is as indicated by the arrow in FIG. 10, and the wind speed is 10 meters per second, the blade's deformation amount is V. The relationship stored in the storage device 9 is shown in Table 1 below.

TABLE 1
Example of Corresponding Relationship.

| Defect Size | Deformation (mm) | Deformation Difference (mm) |
|---|---|---|
| No Defect | 585.50 | 0 |
| Width 10 mm, | 585.75 | 0.25 |
| Length 250 mm | | |
| Width 10 mm, | 589.13 | 3.63 |
| Length 1500 mm | | |

The computing device 5 is further configured to determine the defect size of the structural component L according to the deformation V and the corresponding relationship shown in Table 1.

In the third embodiment of the remote diagnostic system for degradation of structural component proposed in the present disclosure, the at least one shape data is a to-be-tested acoustic signal obtained from a to-be-tested section of the structural component. The shape detection module 1 is an acoustic sensor. The computing device 5 is configured to execute a filtering unit and a diagnostic model. The filtering unit is configured to convert the to-be-tested acoustic signal from a time-domain signal to a frequency-domain signal, extract a frequency band from the frequency-domain signal, and the diagnostic model is configured to determine the defect location in the to-be-tested section according to the frequency band. In an embodiment, the diagnostic model is trained using at least two training acoustic signals through a deep neural network (DNN) or convolutional neural network (CNN), or the like.

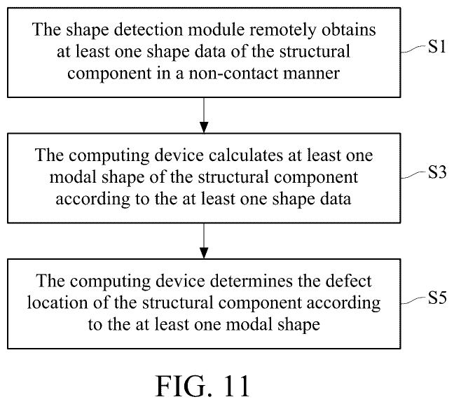

FIG. 11 is a flowchart of the remote diagnostic method for degradation of structural component according to the first embodiment of the present disclosure. This method is applicable to the remote diagnostic system 10 for degradation of structural component of the first embodiment. As shown in FIG. 11, the remote diagnostic method for degradation of structural component in the first embodiment includes steps S1, S3, and S5.

In step S1, the shape detection module 1 remotely obtains at least one shape data of the structural component in a non-contact manner, where the shape detection module 1 includes at least one of an acoustic sensor and an optical sensor. In an embodiment, the shape detection module 1 captures the structural component using an acoustic camera to generate an image file and an audio file as the at least one shape data. In another embodiment, the shape detection module 1 captures the structural component using a high-speed camera to generate a video as the at least one shape data.

In step S3, the computing device 5 calculates at least one modal shape of the structural component according to the at least one shape data. In an embodiment, the computing device 5 performs a beamforming algorithm on a designated location in an image file and an audio file to amplify a sound amplitude at the designated location, and then generates the at least one modal shape according to the sound amplitude of the designated location. In another embodiment, the computing device 5 performs an artificial intelligence (AI) algorithm on the video to obtain a motion trajectory of the structural component and then generates the at least one modal shape according to the motion trajectory.

In step S5, the computing device 5 determines the defect location of the structural component according to the at least one modal shape. As previously mentioned, the structural component applicable to the remote diagnostic method for degradation of structural component in the first embodiment includes at least three components with the same structure. The at least one modal shape includes at least three modals corresponding to the at least three components, respectively. In step S5, the computing device 5 finds a candidate modal from the at least three modals, where among the at least three modals, modals other than the candidate modal are identical to each other but different from the candidate modal. The defect location corresponds to the component associated with the candidate modal among the at least three components. Before step S5, the computing device 5 adopts a deep neural network (DNN) or a convolutional neural network (CNN), trained using at least two training acoustic signals, or similar methods to establish the diagnostic model.

In an embodiment, the at least one shape data is a to-be-tested acoustic signal obtained from a to-be-tested section of the structural component. The shape detection module 1 is an acoustic sensor. In step S5, the computing device 5 executes a filtering unit to convert the acoustic signal from the time domain to the frequency domain, extracts a frequency band from the frequency domain signal, and the computing device 5 executes the diagnostic model to determine the defect location in the to-be-tested section according to the frequency band.

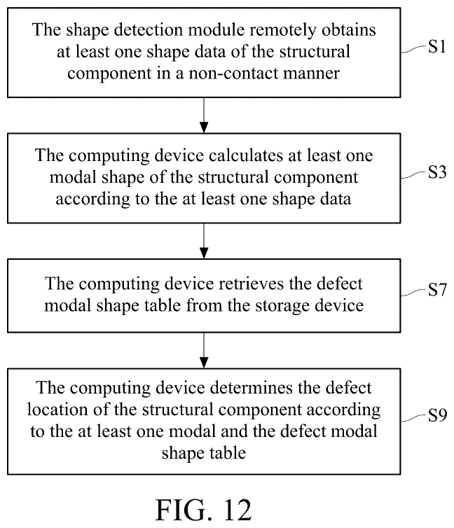

FIG. 12 is a flowchart of the remote diagnostic method for degradation of structural component according to the second embodiment of the present disclosure. The method is applicable to the remote diagnostic system 20 for degradation of structural component in the second embodiment. As shown in FIG. 12, the remote diagnostic method for degradation of structural component in the second embodiment includes steps S1, S3, S7, and S9. The difference between the second embodiment and the first embodiment is the inclusion of steps S7 and S9.

In step S7, the computing device 5 retrieves the defect modal shape table from the storage device 9. Before retrieving the defect modal shape table, the defect modal shape table needs to be established using the Finite Element Method (FEM).

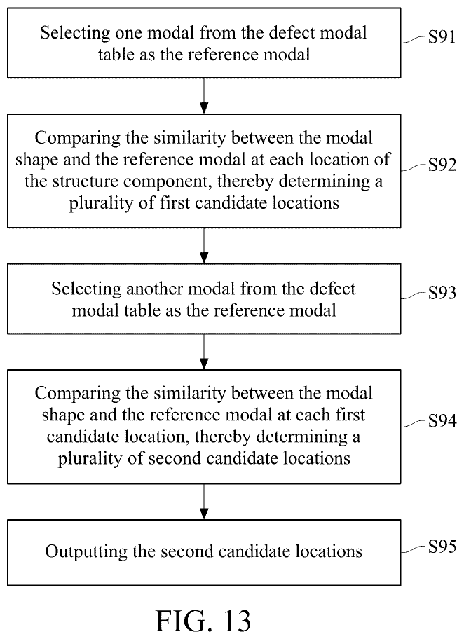

In step S9, the computing device 5 determines the defect location of the structural component according to the at least one modal and the defect modal shape table. FIG. 13 is a detailed flowchart of step S9, which includes steps S91 to S95.

In step S91, the computing device 5 selects one modal (such as modal 1) from the defect modal shape table (as shown in FIG. 7) as the reference modal.

In step S92, at each location (such as from ⅛L to ⅞L), the computing device 5 compares the amplitude of the modal shape (result from step S2) to the amplitude of the selected modal (modal 1) with a defect (such as ½ defect or ¼ defect) to determine a plurality of first candidate defect locations.

In step S93, the computing device 5 selects another modal (such as modal 2) from the defect modal shape table as the reference modal.

In step S94, at each first candidate defect location, the computing device 5 compares the amplitude of the modal shape to the amplitude of the selected modal (modal 2) with a defect (such as ½ defect or ¼ defect) to determine a plurality of second candidate defect locations.

In step S95, the computing device 5 outputs the second candidate defect locations. In other embodiments, the process similar to steps S93 to S94 can be repeated multiple times, using different modals each time to filter the candidate defect locations determined in the previous iteration, ultimately determining at least one final defect location and outputting it.

In an embodiment, the shape detection module 1 includes both an acoustic sensor and an optical detector. The computing device 5 calculates two possible defect locations for the same structural component according to the audio file and image file obtained from these two sensors, and finally determines the defect location according to the overlapping region of the two defect locations.

In an embodiment, after confirming the defect location in step S5 or step S9, the computing device 5 is further configured to send an alert regarding the defect location to an external device, such as sending the alert information to a user's mobile phone or computer through wired or wireless communication over a network. However, the present disclosure is not limited to these examples.

In view of the above, the present disclosure proposes a remote diagnostic system and method for degradation of structural component, where the shape detection module may use at least one of an acoustic or optical sensor to remotely detect the vibration modal shape of the object and diagnose and locate various defect conditions of the structural component in real time.

When a structural component develops defects such as corrosion, thinning, or cracks, the local rigidity and mass of the component change, causing deformation or changes in the natural frequency (modal shape) of the entire structure. Therefore, the remote diagnostic system and method for degradation of structural component proposed by the present disclosure may perform remote intelligent defect detection without damaging or contacting the structural component. This system is applicable to long-distance (over 100 meters) structural defect detection. Furthermore, it is not limited to detecting a single structural component; it can be used for mobile detection of other structural components. The present disclosure uses multiple modal shape shifts for selecting and ultimately determining the defect location. It also uses the Finite Element Method to establish the equivalent characteristic frequency-modal shape relationships for various defects, eliminating the need for past sample data. In the acoustic aspect, the present disclosure utilizes beamforming to capture audio files and focus on the structural component, effectively reducing the impact of surrounding environmental noise. In the optical aspect, as long as the hardware is capable of clearly capturing image files of the structural component, it is sufficient to implement the present disclosure. Furthermore, the use of optical sensors is not affected by environmental noise, allowing the present disclosure to significantly reduce external environmental interference, thereby achieving effective tracking and localization.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A remote diagnostic system for degradation of structural component comprising:
a shape detection module obtaining at least one shape data of a structural component remotely in a non-contact manner, wherein the shape detection module comprises at least one of an acoustic sensor and an optical sensor; and
a computing device communicably connecting to the shape detection module, wherein the computing device is configured to calculate at least one modal shape of the structural component according to the at least one shape data and determine a defect location of the structural component according to the at least one modal shape.

2. The remote diagnostic system for degradation of structural component of claim 1, wherein the acoustic sensor is an acoustic camera configured to capture the structural component to generate an image file and an audio file as the at least one shape data; wherein the computing device is further configured to perform a beamforming algorithm according to a designated location in the image file and the audio file to amplify a sound amplitude at the designated location, and then generate the at least one modal shape according to the sound amplitude at the designated location.

3. The remote diagnostic system for degradation of structural component of claim 1, wherein the optical sensor is a high-speed camera configured to capture the structural component to generate a video as the at least one shape data; wherein the computing device is further configured to perform an artificial intelligence algorithm on the video to obtain a motion trajectory of the structural component, and then generate the at least one modal shape according to the motion trajectory.

4. The remote diagnostic system for degradation of structural component of claim 1, further comprising a storage device communicably connecting to the computing device, wherein the storage device is configured to store a defect modal shape table recording a plurality of reference modals corresponding to a plurality of frequencies; wherein the computing device is further configured to perform a plurality of selections on the at least one modal shape according to the plurality of reference modals to determine the defect location of the structural component.

5. The remote diagnostic system for degradation of structural component of claim 4, wherein the defect modal shape table is established by a finite element method.

6. The remote diagnostic system for degradation of structural component of claim 1, wherein the structural component comprises at least three components of the same structure, and the at least one modal shape comprises at least three modals respectively corresponding to the at least three components; and determining the defect location of the structural component according to the at least one modal shape comprises: finding a candidate modal among the at least three modals, wherein among the at least three modals, modals other than the candidate modal are identical to each other but different from the candidate modal; wherein the defect location is one of the at least three components corresponding to the candidate modal.

7. The remote diagnostic system for degradation of structural component of claim 1, wherein the at least one shape data is a to-be-tested acoustic signal obtained from a to-be-tested section of the structural component, and the shape detection module is the acoustic sensor, the computing device is further configured to execute a filtering unit and a diagnostic model, wherein the filtering unit is configured to convert the to-be-tested acoustic signal from a time-domain signal to a frequency-domain signal, extract a frequency band from the frequency-domain signal, and the diagnostic model is configured to determine the defect location in the to-be-tested section according to the frequency band.

8. The remote diagnostic system for degradation of structural component of claim 7, wherein the diagnostic model is a deep neural network or a convolutional neural network trained using at least two training acoustic signals.

9. A remote diagnostic method for degradation of structural component comprising:
obtaining at least one shape data of a structural component remotely in a non-contact manner by a shape detection module, wherein the shape detection module comprises at least one of an acoustic sensor and an optical sensor;
calculating at least one modal shape of the structural component according to the at least one shape data by a computing device; and
determining a defect location of the structural component according to the at least one modal shape by the computing device.

10. The remote diagnostic method for degradation of structural component of claim 9, wherein the acoustic sensor is an acoustic camera, and obtaining the at least one shape data of the structural component remotely in the non-contact manner by the shape detection module comprises: capturing the structural component to generate an image file and an audio file as the at least one shape data by the acoustic camera;
wherein calculating the at least one modal shape of the structural component according to the at least one shape data by the computing device comprises:
performing a beamforming algorithm according to a designated location in the image file and the audio file to amplify a sound amplitude at the designated location; and
generating the at least one modal shape according to the sound amplitude at the designated location.

11. The remote diagnostic method for degradation of structural component of claim 9, wherein the optical sensor is a high-speed camera, and obtaining the at least one shape data of the structural component remotely in the non-contact manner by the shape detection module comprises: capturing the structural component to generate a video as the at least one shape data;
wherein calculating the at least one modal shape of the structural component according to the at least one shape data by the computing device comprises:
performing an artificial intelligence algorithm on the video to obtain a motion trajectory of the structural component; and
generating the at least one modal shape according to the motion trajectory.

12. The remote diagnostic method for degradation of structural component of claim 11, further comprising:
storing a relationship between a defect size and a deformation amount by a storage device;
determining the deformation amount of the structural component according to the motion trajectory by the computing device; and
determining the defect size of the structural component according to the relationship and the deformation amount by the computing device.

13. The remote diagnostic method for degradation of structural component of claim 9, further comprising:
storing a defect modal shape table recording a plurality of reference modals corresponding to a plurality of frequencies by a storage device;
wherein determining the defect location of the structural component according to the at least one modal shape comprises: performing a plurality of selections on the at least one modal shape according to the plurality of reference modals to determine the defect location of the structural component.

14. The remote diagnostic method for degradation of structural component of claim 13, further comprising:
before storing the defect modal shape table by the storage device, establishing the defect modal shape table by a finite element method.

15. The remote diagnostic method for degradation of structural component of claim 9, wherein the structural component comprises at least three components of the same structure, and the at least one modal shape comprises at least three modals respectively corresponding to the at least three components; and determining the defect location of the structural component according to the at least one modal shape by the computing device comprises: finding a candidate modal among the at least three modals, wherein among the at least three modals, modals other than the candidate modal are identical to each other but different from the candidate modal; wherein the defect location is one of the at least three components corresponding to the candidate modal.

16. The remote diagnostic method for degradation of structural component of claim 9, wherein the at least one shape data is a to-be-tested acoustic signal obtained from a to-be-tested section of the structural component, the shape detection module is the acoustic sensor, and calculating at least one modal shape of the structural component according to the at least one shape data by the computing device comprises:
executing a filtering unit to convert the to-be-tested acoustic signal from a time-domain signal to a frequency-domain signal, and extract a frequency band from the frequency-domain signal by the computing device; and
performing a diagnostic model to determine the defect location in the to-be-tested section according to the frequency band.

17. The remote diagnostic method for degradation of structural component of claim 16, further comprising: using a deep neural network or a convolutional neural network trained with at least two training acoustic signals as the diagnostic model.
